(19) United States
(12) Patent Application Publication
(10) Pub. No.: US 2026/0228748 A1
(43) Pub. Date: Aug. 6, 2026

(54) SYSTEMS AND METHODS FOR MANAGING NOTIFICATIONS FOR ENDPOINT DEVICES USING AN AGNOSTIC SCHEMA

(71) Applicant: Dell Products L.P., Round Rock, TX (US)

(72) Inventors: GOKUL THIRUCHENGODE VAJRAVEL, Bangalore (IN); VIVEKANANDH NARAYANASAMY RAJAGOPALAN, Bangalore (IN)

(21) Appl. No.: 19/043,716

(22) Filed: Feb. 3, 2025

(51) Int. Cl. G06Q 30/01; G06F 11/07

(52) U.S. Cl. CPC G06Q 30/01; G06F 11/0784

(57) ABSTRACT

Methods and systems for managing operation of a data processing system are disclosed. To manage operation of the data processing system, a notification identifying an issue impacting desired computer implemented services from being provided by the data processing system may be obtained. Based at least in part on the notification, a person tasked with managing the issue identified by the notification may be identified and a device from various devices associated with the person may be selected. Agnostic schema for providing notifications to any types of devices may be used to convert the notification into an agnostic format interpretable by any device in order to display the notification to the person. By doing so, the notification may be appropriately displayed in a method invoked by the device, thereby removing the dependency on specific device architectures to notify the user.

### FIELD

Embodiments disclosed herein relate generally to providing customized services to users of data processing systems. More particularly, embodiments disclosed herein relate to systems and methods to managing operation of a data processing system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIGS. 2A-2B show diagrams illustrating data flows in accordance with an embodiment.

FIG. 3 shows a flow diagram illustrating a method for managing operation of at least one data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for providing computer-implemented services to users of data processing systems. To provide the computer-implemented services, the system may include any number of data processing systems (e.g., computing devices, data centers, etc.) with in-band components (e.g., various hardware components and/or software resources). The in-band components may perform various processes including startup processes, software installation processes, and/or other types of processes. When performing these processes, the in-band components may experience an issue (e.g., failure, error, etc.) impacting function of the data processing system and therefore, decreasing the likelihood of the desired computer implemented services of being provided by the data processing system.

In order to manage continued provisioning of the desired computer implemented services, a notification indicating the issue impacting the data processing system may be provided to an endpoint device associated with a user tasked with managing the issue. However, different endpoint devices may include different types of notification delivery methods due to differences in the endpoint device's architectures and/or notification capabilities. As a result, displaying the notification in a manner that allows a user to be notified of the issue and/or initiation of any management action (e.g., by the user) to remediate the issue may be impeded.

Even in the event the notification is able to be provided in a format natively usable by the endpoint device, the data processing system may provide information regarding the issue via select interfaces (e.g., graphical user interfaces) of the endpoint device (e.g., another data processing system, computing device, etc.). For example, the information regarding the issue (e.g., notification indicating error with the in-band components) may be provided through a graphical user interface of the endpoint device operated by an administrator (e.g., technological personnel with authorized management of the data processing system). Thus, requiring a person to be local to the endpoint device in order to provide management services for the data processing system. Consequently, the person tasked with managing the remediation of issues impacting the data processing system may be unable to identify the issues to ensure continued performance of computer implemented services if the person is not local to the endpoint device and/or the endpoint device is not accessible by the person for some reason.

In order to manage remediation of issues impacting data processing systems, a customized notification process to communicate information regarding the issue to a person (e.g., tasked with remediating the issues) may be implemented by a management system. The customized notification process may be established, for example, by an administrator of the data processing systems and may provide criteria for selecting a device from various devices associated with the person. An agnostic schema may be used to convert a notification identifying the issue into an agnostic format that may be interpreted and displayed appropriately on any type of device (e.g., device type independent version of the notification), while prioritizing the notification based on the criteria associated with the selected devices.

The management system may provide the device type independent version of the notification to the person tasked with remediating the issue and/or managing operation of the data processing systems in a customized manner based on the device associated with the person and the agnostic formation of the notification. By doing so, the likelihood of initiating remediation of the issue (e.g., by the person(s)) may be increased, and thereby, increasing the likelihood of facilitating continued provisioning of desired computer implemented services by the data processing system.

In an embodiment, a method for managing operation of a data processing system is disclosed. The method may include: obtaining a notification regarding the data processing system; identifying, based on at least the notification, a person tasked with managing an issue identified by the notification and impacting desired computer implemented services provided by the data processing system; identifying a plurality of devices associated with the person; selecting a first device of the plurality of devices based on metrics regarding the devices; and attempting to notify the person of the issue using the first device and a device type independent version of the notification to initiate management of the issue to facilitate continued provisioning of the desired computer implemented services.

The notification may be customized for a type of device, and may be incompatible for use with other types of devices.

The device type independent version of the notification may be compatible for use with the type of device and the other types of devices.

The device type independent version of the notification may include: content indicating an occurrence of the issue impacting the data processing system; and an invocation of a display method of displaying the content by the first device, and the display method of displaying being unknown to an entity attempting to notify the person.

The device type independent version of the notification may be based, at least in part, on the notification and a schema, the schema may specify allowable and disallowed content of the device type independent version of the notification.

The device type independent version of the notification may be natively usable by the plurality of the devices.

The method may also include: in a first instance of the attempting where the person is not successfully notified: selecting a second device of the plurality of devices based on the metrics regarding the devices, the second device being different from the first device; and attempting to notify the person of the issue using the second device and the device type independent version of the notification.

The method may also include: in a second instance of the attempting where the person is successfully notified: marking the issue as being managed.

The metrics regarding the devices may include at least one selected from a list of metrics consisting of: response times of the person to notifications sent to the devices; a last used device; a most frequently used device; and a computing capabilities of the devices.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

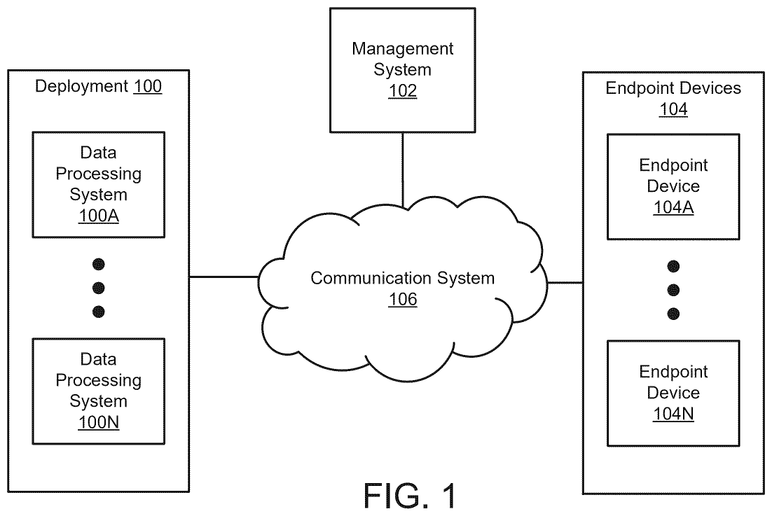

Turning to FIG. 1, a block diagram illustrating a system in accordance with an embodiment is shown. The system shown in FIG. 1 may provide, at least in part, computer-implemented services. The computer-implemented services may include any type and quantity of computer-implemented services. For example, the computer-implemented services may include data storage services, instant messaging services, database services, data generation services, and/or any other type of service that may be implemented with a computing device. The computer-implemented services may be provided by, for example, deployment 100, management system 102, endpoint devices 104, and/or any other type of devices (not shown in FIG. 1). Other types of computer-implemented services may be provided by the system shown in FIG. 1 without departing from embodiments disclosed herein.

To provide the computer-implemented services, deployment 100 may include any number of data processing systems (e.g., data processing system 100A-data processing system 100N). Each of the data processing systems may include hardware components (e.g., processors, memory modules, storage devices, etc.) and/or software components (e.g., operating system, device drivers, application programs, etc.) which may be used, at least in part, to provide the computer-implemented services. For example, deployment 100 may be a data center including various components such as, servers, routers, storage systems, security systems, etc. that host operating systems, applications, etc. that perform different processes in order to provide computer-implemented services.

Over time, operation of the hardware resources and/or software components hosted by the hardware resources (e.g., applications) may be limited and/or fail (e.g., due to insufficient resources, software defects, etc.). Failure of and/or limited operation of the hardware and/or software components may negatively impact continued provisioning of the computer-implemented services by the data processing system. To manage failures and/or reduced functionality of the hardware resources and/or software components hosted by the hardware resources, a monitoring agent may be hosted by the data processing system (e.g., more specifically by the hardware resources of data processing system 100A). The monitoring agent may include a software program responsible for monitoring operation status of the hardware resources and/or software components while providing the computer-implemented services. By monitoring the operation of the hardware resources and/or software components, errors and/or undesired activity impacting operation of the data processing system may be identified, monitored, and/or otherwise managed.

However, the data processing system may lack the capabilities (e.g., due to insufficient resources) to manage the errors and/or issues impacting operation of the data processing system. For example, the data processing system may not have enough computing resources (e.g., processing resources, memory resources, and/or any other computer resources) to consistently monitor, identify, and implement necessary modifications to the software components hosted by the hardware resources (e.g., applications) in order to provide the computer-implemented services desired by the user. Notifications including information regarding errors and/or issues impacting operation of the data processing system may be provided to a management entity (e.g., management console and/or any other management system) operated by a person (e.g., system administrator, information technology decision maker (ITDM), and/or any other person tasked with managing operation of the data processing system).

For example, the person may receive a notification via a graphical user interface (e.g., display, monitor, etc.) hosted by endpoint device 104A. However, the notification (and/or content indicating the occurrence of the issue) may not be displayed by the endpoint device due to differences in endpoint device architecture and/or notification capabilities. For example, the method of displaying content indicating the occurrence of the issue invoked may be based on the type of device and/or notification capabilities of the device.

Even if the format of the notification is usable by the endpoint device, the person may not receive the notification. For example, the graphical user interface may only display a limited amount of information, if any, regarding the error or issue impacting operation of the data processing system. Thus, when such notifications including the information regarding the issue are obtained, a person may need to be local to the data processing system to view the graphical user interface to understand and/or perform an action to initiate remediation of the issue impacting the operation of the data processing system.

In general, embodiments disclosed herein may provide methods, systems, and/or devices for managing operation of a data processing system by providing notifications to various devices in an agnostic manner that meets the natively usable requirements of the respective devices' to display content of the notification. To do so, a plurality of devices associated with a person tasked with managing an issue identified by the notification may be identified. A device may be selected from the plurality of devices based on a set of metrics regarding the different devices. The metrics may be used to obtain a key performance indicator (KPI) associated with each device and the KPI's for each device may be used to rank the devices based on suitability to receive the notification by the user.

The notification may be provided to the selected device in an agnostic format and/or version to allow the selected device to translate the notification in a device-specified format (e.g., customized and unique to the selected device) in order to ensure compatibility with the device's notification system. By communicating the issue to the selected device using the agnostic format of the notification, the person tasked with managing the issue may be more likely to be notified of the issue. By doing so, the likelihood of remediating the issue may be increased while conserving limited resources and thereby facilitating continued provisioning of desired computer implemented services by the data processing system as part of a deployment.

To provide the above noted functionality, the system of FIG. 1 may include deployment 100, management system 102, endpoint devices 104, and communication system 106. Each of these components is discussed below.

Deployment 100 may provide computer-implemented services (e.g., to users of deployment 100 and/or to devices operably connected to deployment 100). To do so, deployment may include any number of data processing systems (e.g., 100A-100N) that may be used by businesses, individuals, and/or other users. Each of the data processing systems (e.g., 100A-100N) may include any number of hardware and/or software components configured to provide the computer-implemented services. When providing the computer-implemented services, for example, data processing system 100A (and/or any of data processing systems of deployment 100) may identify issues negatively impacting operation of data processing system 100A and may communicate information regarding the issues to external devices tasked with managing operation of data processing system 100A.

To perform their functionality, data processing system 100A may: (i) monitor operation of the hardware components and/or software resources (e.g., hosted by the data processing system), (ii) identify an issue impacting operation of data processing system 100A (e.g., any type of issue that requires administrative intervention), (iii) provide one or more communications regarding operation status of the data processing system (e.g., including information regarding the issue) to users (e.g., of the data processing system), management system 102, and/or endpoint devices 104, (iv) receive communications (e.g., including instructions to manage operation of software resources of data processing system 100A) from management system 102, endpoint devices 104, and/or any other authorized management devices, and/or (v) perform other tasks.

To identify the issue, data processing system 100A may host a monitoring agent (e.g., a software program) and/or may communicate with external entities (e.g., management system 102 and/or other management devices). For example, the monitoring software may monitor operation of data processing system 100A and identify issues impacting operation of data processing system 100A. For example, data processing system 100A (e.g., more specifically the monitoring software) may identify an occurrence of a failure by a storage device (hosted by data processing system 100A) to store data and may communicate the issue to management system 102.

Endpoint devices 104 may include any type and/or number of endpoint devices (e.g., 104A-104N). Each endpoint device of endpoint devices 104 may include hardware and/or software components configured to obtain data, store data, provide data to other entities, and/or to perform any other task to facilitate performance of the computer-implemented services. All, or a portion, of endpoint devices 104 may provide (and/or participate in and/or support the) computer-implemented services to various devices operably connected to endpoint devices 104. Different endpoint devices may provide similar and/or different computer-implemented services.

Endpoint devices 104 may receive notifications from management system 102 (e.g., via a communication system) and may access to data and/or manage any of data processing systems 100A-100N. Endpoint devices 104 may be organized so that each endpoint device of endpoint devices 104 is associated with a user of endpoint devices 104, and an endpoint device assigned to a user may be allowed to store, modify, and/or access the data in a data processing system associated with the user. For example, endpoint device 104A and endpoint device 104B may be associated with a first user (e.g., administrator of deployment 100) and endpoint device 104C may be associated with a second user (e.g., another administrator of deployment 100).

To obtain the information regarding issues impacting data processing system 100A by endpoint devices 104, management system 102 may identify a user to be notified of the issue and the mechanism in which information regarding the issue may be communicated through to the identified user to initiate remediation of the issue.

Management system 102 may perform tasks relating to management of and/or facilitation of use of deployment 100 (e.g., any of data processing systems 100A-100N). Management system 102 may include any number and/or type of devices (e.g., other data processing systems, servers, storage devices, user devices) that may be used to manage the data processing systems. As part of managing the data processing systems, management system 102 may train and/or host any number and/or type of machine learning models and/or inference models trained to obtain classifications (e.g., inferences) for different types of issues. The trained machine learning model may include generative artificial intelligence (AI) inference models (e.g., large language models (LLMs)); therefore, the responses may include new instances of data created by the generative AI inference models based on learned associations established during inference model training. For example, the inference models may be trained using unstructured data, such as stories, essays, audio transcription, video description, and/or other types of human interpretable text, to generate responses of the same. The notifications of issues provided to management system 102 by data processing systems 100A-100N may be used as input data for the trained machine learning models managed by management system 102.

To perform its functionality, management system 102 may: (i) obtain notifications and/or any form of communication from data processing systems 100A-100N regarding issues impacting the respective data processing system, (ii) analyze the notifications to identify a type of issue indicated by the notification, (iii) identifying a person tasked with managing the issue impacting the desired computer implemented services being provided by the data processing system (e.g., based on at least the notification and/or the type of issue indicated by the notification), (iv) identify various devices associated with the person (e.g., all the devices registered to the person), (v) select a device from the various devices based on any type of metrics regarding each device (e.g., including response times of the person to notifications sent to the devices, a last used device, a most frequently used device, and/or computing capabilities of the devices), (vi) attempt to notify the person of the issue using the first device (e.g., any of endpoint devices 104) and the device type independent version of the notification, (vii) receiving acknowledgements from the endpoint devices in response to providing the device type independent version of the notification, and/or (viii) perform other tasks.

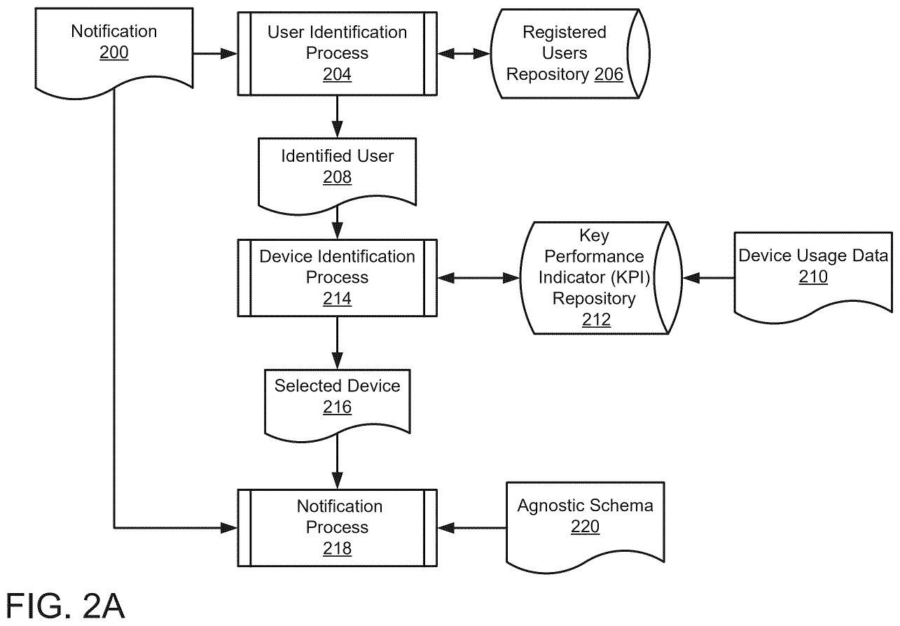

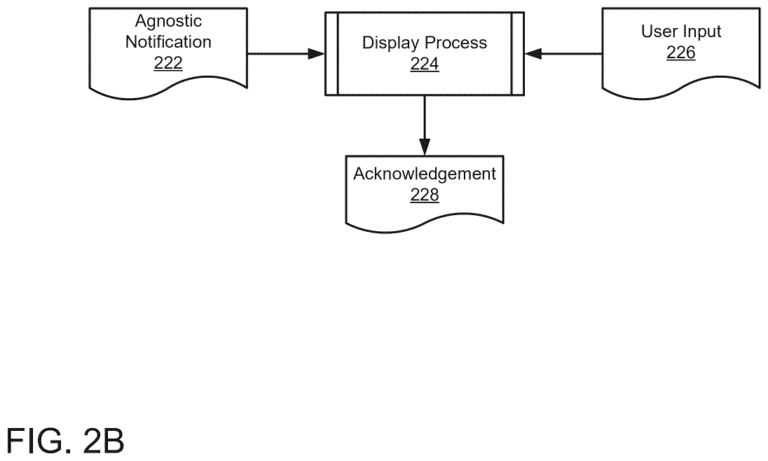

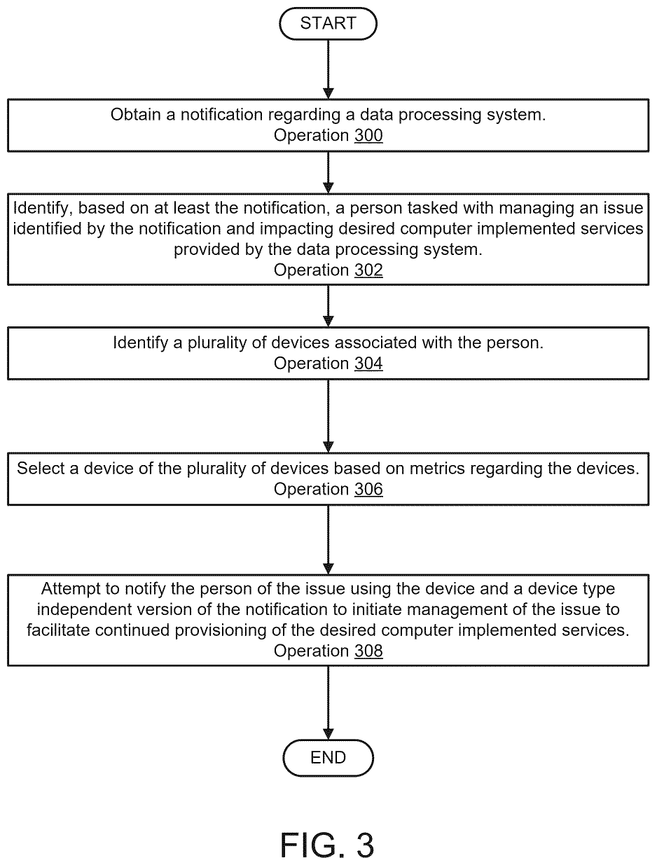

When providing their functionality, any of (and/or components thereof) deployment 100, management system 102, and/or endpoint devices 104 may perform all, or a portion, of the actions and methods illustrated in FIGS. 2A-3.

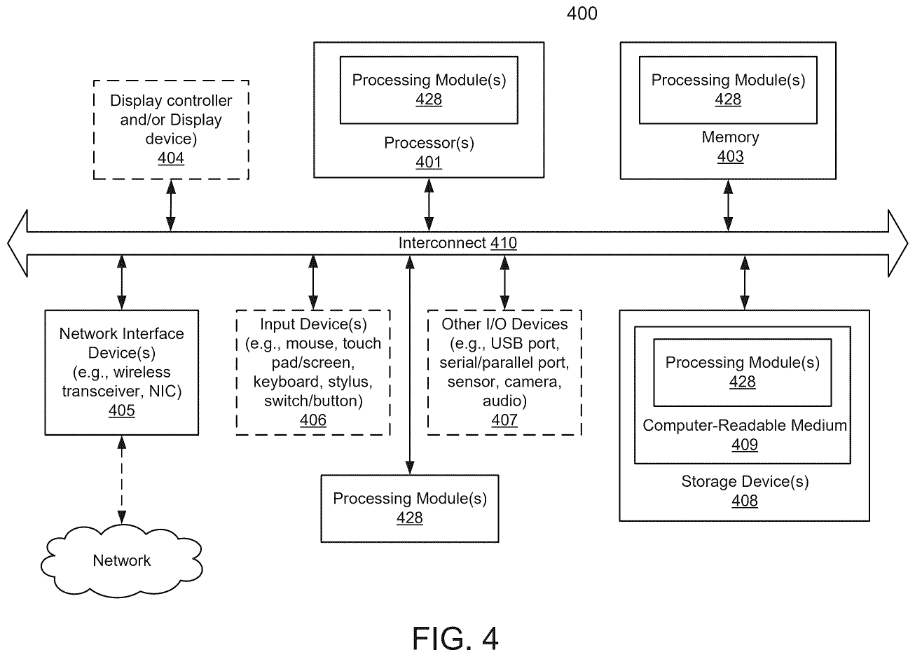

Any of (and/or components thereof) deployment 100, management system 102, and endpoint devices 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. In an embodiment, communication system 106 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2B. In the diagrams, flows of data and processing of data are illustrated using different sets of shapes. A first set of shapes (e.g., 200, 208, etc.) is used to represent data structures, a second set of shapes (e.g., 204, 214, etc.) is used to represent processes performed using and/or that generate data, and a third set of shapes (e.g., 206, 212) is used to represent large scale data structures such as databases.

Turning to FIG. 2A, a first data flow diagram in accordance with an embodiment is shown. The data flow diagram may illustrate data used in and data processing performed in obtaining an agnostic format of a notification to communicate an issue (e.g., impacting operation of a data processing system) to a person (e.g., via a user device associated with the person).

To do so, notification 200 may be obtained from at least one data processing system (e.g., any of data processing systems 100A-100N) of a deployment (e.g., deployment 100). Notification 200 may include a communication indicating an issue impacting operation of at least one data processing system. For example, data processing system 100A may host monitoring software which may monitor operation of the hardware components and/or other software resources (e.g., hosted by data processing system 100A) to identify any types of issues (e.g., failures, errors, etc.) limiting, reducing, and/or otherwise negatively impacting performance of data processing system 100A to provide the desired computer implemented services (e.g., to a user of the data processing system).

For example, an employee of a company may attempt to store data in a database (e.g., storage device and/or any other storage architecture managed by the company) and be unable to successfully store the data in the database as a result of a failure (e.g., a network configuration error, power failure, hardware failure, etc.) impacting the functionality of the database. In this example, notification 200 may include the text “database service down” and an identity of the data processing system being impacted (e.g., any type of information usable to identify the data processing system).

Notification 200 may be used in performing user identification process 204. During user identification process 204, notification 200 may be subjected to any type of analysis process to identify a person (also referred herein as “a user”) tasked with managing an issue (e.g., identified by notification 200) impacting the desired computer implemented services being provided by a data processing system (e.g., data processing system 100A-100N). The user tasked with managing the issue may be identified from registered users repository 206.

Registered users repository 206 may include any type of repository (and/or other storage architecture) storing any quantity of users associated with managing various types of issues that may impact the desired computer implemented services provided by any of the data processing systems (e.g., data processing systems 100A-100N). For example, registered users repository 206 may include a database of individual users associated with managing different types of issues that may impact operation of a data processing system.

To identify the user associated with managing the issue, notification 200 may be subjected to any type of analysis process to identify the type of issue and/or any other information regarding the issue. For example, a large language model may be used to identify words and/or phrases included in notification 200 that are associated with a type of issue impacting data processing system 100A. For example, notification 200 may include the text “firmware update for storage system”. Based on the text, it may be identified that the word “storage” and the phrase “firmware update” may be used to identify the type of issue impacting the data processing system.

Once identified, the type of issue may be used to perform a lookup process as part of performing user identification process 204. During the lookup process, the type of issue may be used as a key to perform a lookup in a lookup table (e.g. including different types of issues associated with different users) to identify the person associated with managing the issue. Continuing the above example, the type of issue may include “storage” and an identifier for an issue relating to “storage” may be used a key to identify the user tasked with managing issues impacting a storage system (e.g., IT administrator, SME, etc.).

While described above with respect to identifying a single person or user tasked with managing the issue (e.g. identified by notification 200), it will be appreciated that any number of users associated with managing the issue may be identified.

As a result of performing user identification process 204, identified user 208 may be obtained. Identified user 208 may include: (i) identifier for the user associated with managing the issue, (ii) any information obtained from registered users repository 206 usable to identify the user, and/or (iii) other information.

Once identified, identified user 208 may be used to perform device identification process 214. During device identification process 214, a device associated with the user may be selected from (any quantity of) devices associated with the user. In order select a device (e.g., to obtain selected device 216), devices associated with the user may be identified. For example,

[symbol]

To obtain selected device 216, a device may be selected based on a key performance indicator (KPI) associated with the device. To obtain the key performance indicator for each device, device usage data 210 may be obtained. Device usage data 210 may include any quantity and type of data regarding use of a device (e.g., any of endpoint devices 104A-104N) via operation by the identified user (e.g., IT administrator, SME, etc.). Device usage data 210 may be obtained from the device operated by the identified user and may be obtained as frequently as updated data regarding usage of the device is available. For example, if a user operates a smartphone (e.g., endpoint device 104A), the data regarding operation of the smartphone including frequency of use, response times of the user to notifications sent to the smartphone, and/or any other information relating to operation of the smartphone may be provided to management system 102.

Based on device usage data 210, KPI for each of the devices associated with the user may be computed and the devices associated with the user may be ranked according to the KPI established by an administrator, SME, and/or other management entity. The KPI may include any type of metrics, measurements, or other type of label regarding the devices. For example, KPI may include: (i) response times of the person to notifications sent to the respective devices, (ii) a last used device, (iii) a most frequently used device, (iv) computing capabilities of the respective devices, and/or (v) other information.

Once obtained, the KPI's associated with each device may be stored in KPI repository 212. KPI repository 212 may also store device usage data 212 obtained for each device associated with a user (e.g., a registered user identified from registered users repository 206).

As part of performing device identification process 214, a rank ordering of the devices may be based on the KPI's associated with each device and the highest ranked device may be selected in a first attempt to notify the user of the issue. By attempting to notify the user using the highest ranked device, a likelihood of successfully notifying the user of the issue may be improved. For example, if the frequency of usage is used as the KPI during rank ordering of the devices for an employee (e.g. identified user 208) working as an IT administrator for a company, and the most frequently used device by the employee may be a smartphone, the smartphone may be selected as a first device to use for notifying the employee of the issue.

As a result of performing device identification process 214, selected device 216 may be obtained. Selected device 216 may include: (i) an identifier for the device selected to be used to notify the user of the issue, (ii) information regarding the type of the device, and/or (iii) any other information.

Once selected device 216 is obtained, notification process 218 may be performed to obtain an agnostic notification (e.g., compatible for use with any type of device). During notification process 218, notification 200 and agnostic schema 220 may be used to generate an agnostic form of the notification.

Agnostic schema 220 may include a schema for providing notifications to any type of devices to notify a user of an issue impacting the desired computer implemented services being provided by the data processing system. Agnostic schema 220 may be device independent thereby allowing the receiving device to render the notification and display the notification in a manner natively used by the device. For example, agnostic schema 220 may be used to generate an agnostic notification that is natively usable by any type of device. Agnostic schema 220 may specify allowable and disallowed content indicating an occurrence of the issue impacting a data processing system (e.g., data processing system 100A-100N) to include in the notification provided to the selected device (e.g., selected device 216). For example, agnostic schema 220 may specify criteria for the content to include as part of the notification to be provided to the user independent of the type of device. For example, agnostic schema 220 may specify the content of the notification to include: (i) type of notification, (ii) title of the notification, (iii) detailed message of the notification, (iv) indicator if the notification is time sensitive, (v) expiration time for the notification, (vi) list of possible actions for the notification, (viii) detailed message or command for the action, and/or (ix) any other information.

Continuing the above example of a notification indicating “storage firmware update available”, the agnostic notification may indicate the type of notification is “storage”, the title of the notification is “storage firmware update available”, the message of the notification to be “a new firmware update is available for the storage system”, the notification is “not time sensitive”, and the possible actions for the notification to be “install now”, “install after hours”, and/or “defer”.

By using the agnostic schema (e.g., agnostic schema 220), the content of the notification may be obtained while allowing the method of displaying the content to be invocated based on the device (e.g., type of device). For example, invocation of a method of displaying the content may be based on the architecture of the selected device (e.g., type of device), and thereby, execution of displaying the content (e.g., indicating the occurrence of the issue) may be depend on the type of device.

As a result of performing notification process 218, the agnostic notification may be provided to the selected device (e.g., selected device 216) and information regarding the issue impacting a data processing system may be communicated to a person tasked with managing the issue. By doing so, the likelihood of initiating remediation of the issue impacting the data processing system may be increased and thus, improving the likelihood of deployment 100 being able to provide the desired computer implemented services.

Turning to FIG. 2B, a second data flow diagram in accordance with an embodiment is shown. The data flow diagram may illustrate data used in and data processing performed in displaying a notification (e.g., agnostic notification) on a device to notify a person (e.g., associated with the device) tasked with managing an issue identified by the notification.

To do so, agnostic notification 222 may be obtained (e.g., from management system 102). Agnostic notification 222 may be obtained by a first device (e.g., any of endpoint devices 104) associated with the person to be notified. For example, agnostic notification 222 may be obtained by endpoint device 104A from management system 102.

Agnostic notification 222 may include a notification with content indicating an occurrence of the issue impacting the data processing system (e.g., any of data processing systems 100A-100N). The format of the notification may be agnostic to the type of device (e.g., compatible for use with any type of devices). For example, agnostic notification 222 may be received in a generic, device-independent format that is natively usable by the receiving device (e.g., endpoint device 104A). The agnostic notification may allow the content and priority of the notification to be preserved without being tied to a specific device's architecture or notification system.

Once received, agnostic notification 222 may be used in performing display process 224 to notify the person via the device (e.g., via a graphical user interface of endpoint device 104A). During display process 224, agnostic notification 222 may be ingested by the selected device (e.g., more specifically by a central processing unit of the device) and determines how the agnostic notification should be displayed (e.g. to the user via the graphical user interface of the selected device).

As part of performing display process 224, agnostic notification 222 may be translated into a format compatible with the selected device. For example, depending on the device's specific architecture, notification capabilities, etc., the method of displaying the content by the selected device may be invoked based on the method of display associated with the device type and/or architecture. As such, the selected device may translate the agnostic notification to a specific notification that is native to that device type and/or architecture. For example, the notification may be formatted in a specific way that is custom and unique to the respective device type and/or architecture (e.g., differing architecture of a smartphone versus a smart speaker). For example, a smartphone may display a pop-up message of the notification on the screen of the smartphone, while a smart speaker may provide an audible alert of the notification.

Upon translating agnostic notification 222 into a device specific notification, the content (e.g. indicating the occurrence of the issue impacting the data processing system) may be displayed by the selected device (e.g., endpoint device 104) in an attempt to notify the user of the issue (e.g., via interaction with the graphical user interface of the selected device).

As part of performing display process 224, a determination regarding whether the attempt to notify the user of the issue impacting the data processing system is successful may depend on user interaction with the notification (e.g., via operation of the selected device). For example, management system 102 may monitor for an acknowledgement of the user interacting with the displayed content by the selected device and if no interaction by the user is identified, a determination may be made that the attempt to notify the user was not successful. If no acknowledgement is received, management system 102 may select a second device associated with the user (e.g., from KPI repository 212) and may attempt to notify the user of the issue using the second device.

If the attempt to notify the user of the issue impacting the data processing system is successful, user input 226 indicating an interaction with the displayed notification by the user (e.g., via the graphical user interface) may be obtained. For example user input 226 may include any type of interaction the user has with the content displayed by endpoint device 104 such as, acknowledging, dismissing, and/or acting upon the notification displayed. User input 226 may be used to determine whether or not the notification has been successfully addressed (e.g., via the user operating the selected device).

Once user input 226 is obtained, an acknowledgement (e.g., acknowledgement 228) may be obtained and provided in response to agnostic notification 222. Acknowledgement 228 may include: (i) an indication regarding the content from agnostic notification 222 was able to be displayed by the selected device to notify the user of the issue impacting the data processing system, (ii) the type of user interaction, and/or (iii) any other information. For example, acknowledgement 228 may be provided by endpoint device 104A to management system 102.

By doing so, a notification indicating an issue impacting a data processing system may be displayed on a device in a manner that is agnostic to the device type and/or architecture.

Thus, by implementing the data flows shown in FIGS. 2A-2B, a system in accordance with embodiments disclosed herein may have an increased likelihood of providing communications regarding issues impacting data processing systems to one or more people tasked with managing issues impacting operation of a data processing system (e.g., administrator(s) of the data processing systems). By doing so, the likelihood of initiating remediation of the issues to facilitate continued provisioning of desired computer implemented services (e.g., by the data processing systems) may be increased. Consequently, a resource cost (e.g., computational resources, time resources, cognitive resources) of providing ineffective communications may be reduced.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1-2B may perform various methods for managing operation of a data processing system. FIG. 3 illustrate a method that may be performed by the components of the system of FIGS. 1-2B. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a data processing system in accordance with an embodiment is shown. The method may be performed, for example, by any of the components of the system of FIG. 1, and/or any other entity without departing from embodiments disclosed herein.

At operation 300, a notification regarding a data processing system may be obtained. The notification may be obtained by (i) reading the notification from storage, (ii) receiving the notification from another entity, and/or (iii) performing other methods. The notification may be customized for a type of device and may be incompatible for use with other types of devices.

At operation 302, a person tasked with managing an issue identified by the notification and impacting desired computer implemented services provided by the data processing system may be identified. Identifying the person may include: (i) analyzing the notification to identify words and/or phrases regarding the issue (e.g., via any analysis method performed by inference model, SME, etc.), (ii) performing a search in a data repository using the identified words and/or phrases as keywords for the search to identify entries in the data repository including the person (and/or people) associated with managing the type of issue, (iii) extracting an identifier for the person from the identified entries, and/or (iv) other methods.

At operation 304, a plurality of devices associated with the person may be identified. Identifying the plurality of devices associated with the person may include: (i) performing a lookup process in a database (e.g., including identifiers for person(s) and the devices associated with the person(s)) using the identifier for the person as a key for a lookup table included in the database, (ii) obtaining, as a result of performing the lookup process, a list of devices associated with the person, and/or (iii) other methods. Identifying the plurality of devices associated with the person may also include providing a request for the plurality of devices to another entity and receiving an identification of the plurality of devices associated with the person (e.g., a list of identifiers for the devices registered to the person) in response.

At operation 306, a device of the plurality of devices may be selected based on metrics regarding the devices. Selecting the device of the plurality of devices may include: (i) obtaining device use information for the plurality of devices, (ii) performing, using the device use information, an ordering process to obtain a rank ordering of the plurality of devices, (iii) selecting the highest ranked device of the rank ordering of the plurality of devices, and/or (iv) other methods.

Obtaining the device use information for the plurality of devices may include: (i) reading the device use information for the plurality of devices from storage (e.g., from a device usage database and/or other storage architecture), (ii) receiving the device use information for the plurality of devices from another entity, (iii) monitoring the use of the devices (e.g., each device of the plurality of devices associated with the person) over a period of time to obtain device use information for the devices, and/or (iv) other methods.

Performing the ordering process may include: (i) computing a key performance indicator (KPI) for each device of the plurality of devices based on the device use information, (ii) ranking the devices based on the KPI associated with the device to obtain the rank ordering of the plurality of devices, and/or (iii) other methods.

Selecting the highest ranked device of the rank ordering of the plurality of devices may include: (i) identifying the device with the highest ranking of the rank ordered devices, (ii) extracting an identifier for the highest ranked device, and/or (iii) other methods.

At operation 308, the person may be attempted to be notified using the device and a device type independent version of the notification to initiate management of the issue to facilitate continued provisioning of the desire computer implemented services. Attempting to notify the person of the issue may include: (i) obtaining the device type independent version of the notification, (ii) providing the device type independent version of the notification to the first device (e.g., via a message over a communication system, via a graphical user interface (GUI) on the first device), and/or (iii) other methods.

If the person is able to be notified of the issue using the first device (e.g., a response acknowledging receipt of the device type independent version of the notification was received from the first device), the method may include marking the issue as being managed. Marking the issue as being managed may include: (i) updating a status of the issue in a notification database (e.g., including a list of notifications indicating issues impacting operation of data processing systems and status of management of the issue), (ii) providing the response of the acknowledgement to another entity responsible for managing issues impacting desired computer implemented services provided by the data processing system, and/or (iii) other methods.

If the person is unable to be notified of the issue using the first device (e.g., no response acknowledging receipt of the device type independent version of the notification was received from the first device), the method may include: (i) selecting a second device of the plurality of devices based on the metrics regarding the devices, (ii) attempting to notify the person of the issue using the second device and the device type independent version of the notification, and/or (iii) other methods.

Selecting the second device of the plurality of devices based on the metrics regarding the devices may include: (i) identifying a second highest ranked device of the rank ordering of the plurality of devices, (ii) selecting the second highest ranked device of the rank ordering of the plurality of devices, and/or (iii) other methods.

Attempting to notify the person of the issue may include: (i) obtaining the device type independent version of the notification, (ii) providing the device type independent version of the notification to the second device (e.g., via a message over a communication system, via a graphical user interface (GUI) on the second device), and/or (iii) other methods.

The method may end following operation 308.

Thus, using the methods illustrated in FIG. 3, embodiments disclosed herein may provide systems and methods usable to managing operation of a data processing system by communicating an issue impacting operation of a data processing to a person using an agnostic format of a notification identifying the issue. By communicating the issue to a device using the agnostic format of the notification, the person tasked with managing the issue may be more likely to be notified of the issue. By doing so, the likelihood of remediating the issue may be increased while conserving limited resources and thereby facilitating continued provisioning of desired computer implemented services by the data processing system as part of a deployment.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing operation of a data processing system, the method being performed by a computing device configured as a management system that manages the data processing system and comprising:
obtaining a notification regarding the data processing system;
identifying, based on at least the notification, a person tasked with managing an issue identified by the notification, the issue being a failure or an error of the data processing system that cause the data processing system to be unable to continue providing desired computer implemented services being provided by the data processing system before occurrence of the issue;
identifying a plurality of devices associated with the person, the plurality of devices being different types of devices;
selecting a first device of the plurality of devices based on metrics regarding the devices, the notification being incompatible for use by the first device to notify the person of the issue, and the first device not being selected based on a compatibility of the first device for using the notification;
generating a device type independent version of the notification that is compatible for use by the first device to notify the person of the issue, the device type independent version being generated independent of notification capabilities of the first device; and
notifying the person of the issue by providing the device type independent version of the notification to the first device to cause initiation of a management of the issue to fix the failure or the error of the data processing system such that the data processing system can continue to provision the desired computer implemented services.

2. The method of claim 1, wherein the notification is customized for and compatible with only a first type of device among the different types of devices, and the first device being a second type of device among the different types of devices that is different from the first type of device.

3. The method of claim 2, wherein the device type independent version of the notification is compatible for use by all of the different types of devices to notify the person of the issue.

4. The method of claim 3, wherein the device type independent version of the notification comprises:
content indicating an occurrence of the issue impacting the data processing system; and
an invocation of a display method of displaying the content by the first device, and the display method of displaying the content by the first device being unknown to the management system.

5. The method of claim 1, wherein the device type independent version of the notification is based, at least in part, on the notification and a schema, the schema specifying allowable and disallowed content of the device type independent version of the notification.

6. The method of claim 5, wherein the device type independent version of the notification is natively usable by each of the plurality of devices to respectively generate customized notifications for notifying the person of the issue.

7. The method of claim 1, further comprising:
in a first instance of the notifying using the first device where the person is not successfully notified:
selecting a second device of the plurality of devices based on the metrics regarding the devices, the second device being different from the first device; and
notifying the person of the issue using the second device and the device type independent version of the notification.

8. The method of claim 7, further comprising:
in a second instance of the notifying using the first device where the person is successfully notified:
marking the issue as being managed.

9. The method of claim 1, wherein the metrics regarding the devices comprises at least one selected from a list of metrics consisting of:
response times of the person to notifications sent to the devices;
a last used device;
a most frequently used device; and
a computing capabilities of the devices.

10. A non-transitory machine-readable medium having instructions stored therein, which when executed by a processor of a management system, cause the processor to perform operations for managing operation of a data processing system, the operations comprising:
obtaining a notification regarding the data processing system;
identifying, based on at least the notification, a person tasked with managing an issue identified by the notification, the issue being a failure or an error of the data processing system that cause the data processing system to be unable to continue providing desired computer implemented services being provided by the data processing system before occurrence of the issue;
identifying a plurality of devices associated with the person, the plurality of devices being different types of devices;
selecting a first device of the plurality of devices based on metrics regarding the devices, the notification being incompatible for use by the first device to notify the person of the issue, and the first device not being selected based on a compatibility of the first device for using the notification;
generating a device type independent version of the notification that is compatible for use by the first device to notify the person of the issue, the device type independent version being generated independent of notification capabilities of the first device; and
notifying the person of the issue by providing the device type independent version of the notification to the first device to cause initiation of a management of the issue to fix the failure or the error of the data processing system such that the data processing system can continue to provision the desired computer implemented services.

11. The non-transitory machine-readable medium of claim 10, wherein the notification is customized for and compatible with only a first type of device among the different types of devices, and the first device being a second type of device among the different types of devices that is different from the first type of device.

12. The non-transitory machine-readable medium of claim 11, wherein the device type independent version of the notification is compatible for use by all of the different types of devices to notify the person of the issue.

13. The non-transitory machine-readable medium of claim 12, wherein the device type independent version of the notification comprises:
content indicating an occurrence of the issue impacting the data processing system; and
an invocation of a display method of displaying the content by the first device, and the display method of displaying the content by the first device being unknown to the management system.

14. The non-transitory machine-readable medium of claim 10, wherein the device type independent version of the notification is based, at least in part, on the notification and a schema, the schema specifying allowable and disallowed content of the device type independent version of the notification.

15. The non-transitory machine-readable medium of claim 14, the device type independent version of the notification is natively usable by the plurality of the devices.

16. A management system, comprising:
a processor; and
a memory coupled to the processor to store instructions, which when executed by the processor, cause the processor to perform operations for managing operation of a data processing system, the operations comprising:
obtaining a notification regarding the data processing system;
identifying, based on at least the notification, a person tasked with managing an issue identified by the notification, the issue being a failure or an error of the data processing system that cause the data processing system to be unable to continue providing desired computer implemented services being provided by the data processing system before occurrence of the issue;
identifying a plurality of devices associated with the person, the plurality of devices being different types of devices;
selecting a first device of the plurality of devices based on metrics regarding the devices, the notification being incompatible for use by the first device to notify the person of the issue, and the first device not being selected based on a compatibility of the first device for using the notification;
generating a device type independent version of the notification that is compatible for use by the first device to notify the person of the issue, the device type independent version being generated independent of notification capabilities of the first device; and
notifying the person of the issue by providing the device type independent version of the notification to the first device to cause initiation of a management of the issue to fix the failure or the error of the data processing system such that the data processing system can continue to provision the desired computer implemented services.

17. The management system of claim 16, wherein the notification is customized for and compatible with only a first type of device among the different types of devices, and the first device being a second type of device among the different types of devices that is different from the first type of device.

18. The management system of claim 17, wherein the device type independent version of the notification is compatible for use by all of the different types of devices to notify the person of the issue.

19. (canceled)

20. (canceled)

21. The method of claim 1, wherein the device type independent version of the notification comprises notification related information comprising at least a type of notification to be provided to the person, a detailed message regarding the issue, and an expiration time for the notification.

22. The method of claim 21, wherein the first device uses the notification related information included in the device type independent version of the notification to generate a new notification that is compatible for use by the first device to notify the person about the issue.
